(19) United States
(12) Patent Application Publication
(10) Pub. No.: US 2007/0266233 A1
(43) Pub. Date: Nov. 15, 2007

(54) METHOD AND APPARATUS TO MINIMIZE LATENCY BY AVOIDING SMALL TCP SEGMENTS IN A SSL OFFLOAD ENVIRONMENT

(76) Inventors: Mahesh Jethanandani, Saratoga, CA (US); Murali Bashyam, Fremont, CA (US); Nagaraj A. Bagepalli, San Jose, CA (US); Abhijit Patra, San Jose, CA (US)

Correspondence Address: PATTERSON & SHERIDAN, LLP/CISC, 3040 POST OAK BLVD., SUITE 1500, HOUSTON, TX, 77056-6582, US

(21) Appl. No.: 11/383,093

(22) Filed: May 12, 2006

(51) Int. Cl. H04L 9/00

(52) U.S. Cl. 713/153

(57) ABSTRACT

Methods and apparatus for secure network communication in a Secure Sockets Layer (SSL) by avoiding small Transmission Control Protocol (TCP) packets are provided. For some embodiments, these small packets may be avoided by adjusting a maximum segment size (MSS) used in transmissions between an encryption engine and a server to compensate for the amount of overhead added by the encryption process.

### BACKGROUND OF THE INVENTION

1. Field of the Invention

Embodiments of the present invention generally relate to the field of secure communication between networked computers, and more particularly to Secure Sockets Layer (SSL) sessions in a distributed network.

2. Description of the Related Art

For the vast majority of network communications (e.g. the internet), unsecured transmission is acceptable. However, information transmitted according to the Transmission Control Protocol/Internet Protocol (TCP/IP) is vulnerable to eavesdropping and tampering. Systems connected to the internet may intercept, replay, or reproduce an IP packet. Thus, more sensitive information such as financial transactions, medical records, and confidential company business require secure transmission. In response to the desire for secure network communications, a standard for security protocol known as the Secure Sockets Layer (SSL) was developed by Netscape Communications Corporation.

SSL is an enhancement to the TCP/IP standards of network protocol for secure communication between two devices. Secure communication within SSL involves adding a message authentication code (MAC) to the application data, as well as various headers (e.g. SSL record header, Ethernet header, TCP header with a length of 40 bytes to handle the flow of application data between two devices, and an IP header to help determine the network path). The application data, MAC, and headers may be encrypted using a symmetric cipher within an SSL encryption engine deployed in the network.

The SSL encryption engine may be deployed at one of several locations throughout a network. During normal operation, the SSL encryption engine may serve as a TCP proxy to bind an encrypted client connection, communicating with cipher text data, to the unencrypted server connection, communicating with clear text data. The SSL encryption engine may decrypt secure (encrypted) traffic received on the client connection and forward it to the server connection. Clear text data from the server may be encrypted by the SSL encryption engine and sent on to the client.

In order to allow larger pieces of data to be exchanged than can be handled in a single packet, requested data is often be broken up into segments. When negotiating a connection, a client and server will typically establish a maximum segment size (MSS). The MSS is the largest amount of data, typically specified in bytes, that a computer or communications device can handle in a single unfragmented piece. In a secure environment, when the SSL encryption engine receives clear text data from the server that is already equal to the MSS, the overhead of additional bytes due to the encryption process (e.g., the headers and MAC) may cause a full size segment to be resegmented into one full size and one partial size segment.

This is illustrated in FIG. 1a, which shows an SSL encryption engine 108 receiving a segment of clear text 101 from a secure server 104 (e.g., in response to a request from a client 102). As illustrated, while the segment of clear text 101 has a size equal to MSS, the resulting cipher text 113 generated by the encryption engine 110 has a size that is greater than MSS by an amount equal to the encryption overhead (OH). As illustrated in FIG. 1b, because the same value for MSS has been established between the encryption engine 108 and the client 102, only a first portion 114 of the cipher text 113 can be sent in a full size segment, leaving a remaining portion (or partial segment) 116.

While the full size segment will be transmitted immediately, how the partial segment is sent may depend on the system configuration. For example, if a Nagle algorithm is enabled, the partial segment will be held by TCP, as long as more unacknowledged data remains, until it can be coalesced with other partial size segments to form a full size segment for transmission. This is illustrated in FIG. 1b, by a second full segment sent in a packet 118 that includes the remaining portion 116 of the first block of cipher text, as well as a first portion 120 of a second block of cipher text generated by the encryption engine (having a size MSS-OH). In like manner, a remaining portion of the second block of cipher text may be sent with a first portion of a subsequent block of cipher text, with this cycle repeating as necessary.

Unfortunately, enabling the Nagle algorithm may create a substantial delay (e.g., up to a 200 ms delay) for a single full size clear text segment transmitted from the server, and repeated occurrences of this resegmentation can add up to several seconds of delay to the transaction. If the Nagle algorithm is disabled, the resegmentation will still occur, but the full size segment and the partial size segment will be transmitted in turn without waiting. The penalty in transmitting several small packets that could have been combined is again wasted time and increased latency from the start of transmission.

Accordingly, what is needed is a method to avoid the resegmentation of full size TCP MSS segments due to the addition of overhead bytes during the SSL encryption process in an effort to reduce the transmission latency.

### SUMMARY OF THE INVENTION

One embodiment provides a method of performing secure network communication. The method generally includes performing a Secure Sockets Layer (SSL) handshake between a client and an SSL encryption engine to establish a connection with a first maximum segment size (MSS) for transactions therebetween, calculating an adjusted maximum segment size (AMSS) that is less than the first MSS, based on a selected cipher suite used by the encryption engine, and establishing a connection between the encryption engine and a server, the connection using the AMSS for transactions between the encryption engine and the server.

Another embodiment provides a network device generally including a first interface for establishing a connection with a client, a second interface for establishing a connection with a server, and encryption logic. The encryption logic is generally configured to establish, on the first interface, a connection with the client with a first maximum segment size (MSS) for transactions therebetween, to calculate an adjusted maximum segment size (AMSS) that is less than the first MSS, based on a selected cipher suite, and to establish a connection between the encryption engine and a server using the AMSS for transactions between the encryption engine and the server.

Another embodiment provides an encryption engine generally including logic configured to establish a secure connection with a client with a first maximum segment size (MSS) for transactions therebetween, to calculate an adjusted maximum segment size (AMSS) that is less than the first MSS, based on a selected cipher suite, and to establish a connection between the encryption engine and a server using the AMSS for transactions between the encryption engine and the server.

Another embodiment provides a network device generally including first means for establishing a connection with a client, second means for establishing a connection with a server, and logic means. The logic means generally used for establishing, on the first interface, a connection with the client with a first maximum segment size (MSS) for transactions therebetween, calculating an adjusted maximum segment size (AMSS) that is less than the first MSS, based on a selected cipher suite, and establishing a connection between the encryption engine and a server using the AMSS for transactions between the encryption engine and the server.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1a is a prior art block diagram of a network Secure Sockets Layer (SSL) offload environment illustrating only a single client and a server with clear text data being transmitted from the server to an SSL encryption engine with a maximum segment size of MSS and with cipher text data being generated by the SSL encryption engine with a size greater than the maximum segment size of MSS by an amount equal to the encryption overhead (OH);

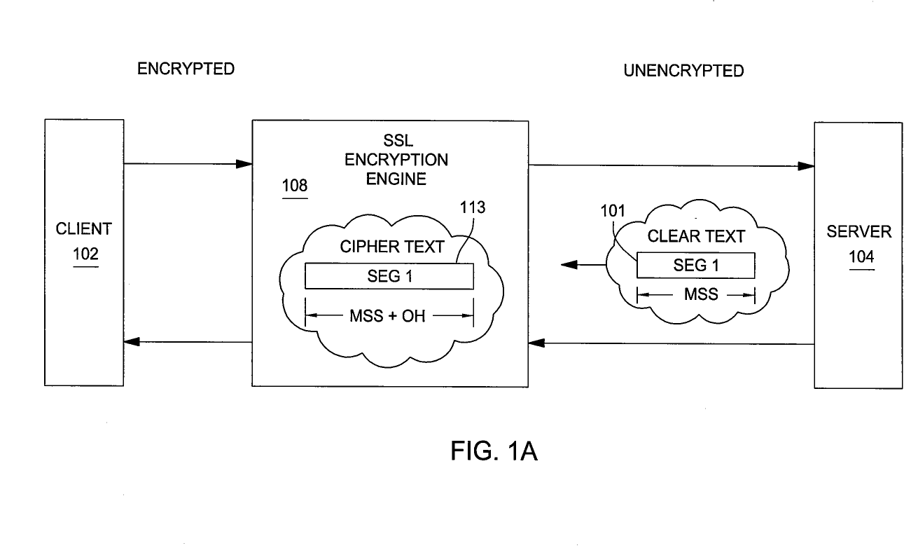

FIG. 1b is a prior art block diagram of a network SSL offload environment illustrating only a single client and a server with a first portion of a first cipher text data packet being transmitted from the SSL encryption engine to the client in a first full size segment equal to MSS and with a remaining portion of the first cipher text data packet being transmitted to the client along with a first portion of a second cipher text data packet in a second full size segment equal to MSS;

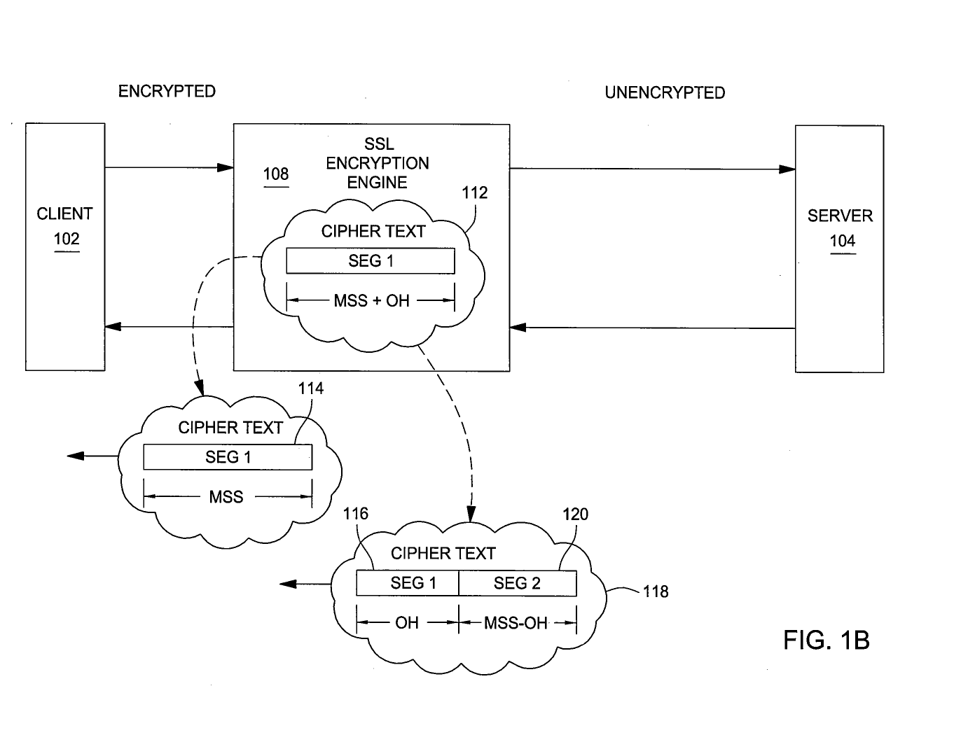

FIG. 2a is a block diagram of a network SSL offload environment illustrating only a single client and a server before a server connection has been established in accordance with one embodiment of the present invention;

FIG. 2b is a block diagram of a network SSL offload environment illustrating only a single client and a server with an adjusted maximum segment size (AMSS) being advertised as the server connection is established in accordance with one embodiment of the present invention;

FIG. 2c is a block diagram of a network SSL offload environment illustrating only a single client and a server with clear text data being transmitted from the server to the SSL encryption engine with an adjusted maximum segment size of AMSS in accordance with one embodiment of the present invention;

FIG. 2d is a block diagram of a network SSL offload environment illustrating only a single client and a server with cipher text data being transmitted from the SSL encryption engine to the client with a maximum segment size of MSS in accordance with one embodiment of the present invention;

FIG. 3 is a block diagram of a component for generating an adjusted maximum segment size (AMSS) based on an established maximum segment size (MSS) and a cipher type; and

FIG. 4 is a flowchart depicting a method to avoid small TCP segments in an effort to minimize latency in an SSL offload environment in accordance with one embodiment of the present invention.

### DETAILED DESCRIPTION

Embodiments of the present invention provide a means for secure network communication in a Secure Sockets Layer (SSL) by avoiding small Transmission Control Protocol (TCP) packets. These small packets may be avoided by adjusting a maximum segment size (MSS) used in transmissions between an encryption engine and a server to compensate for the amount of overhead added by the encryption process.

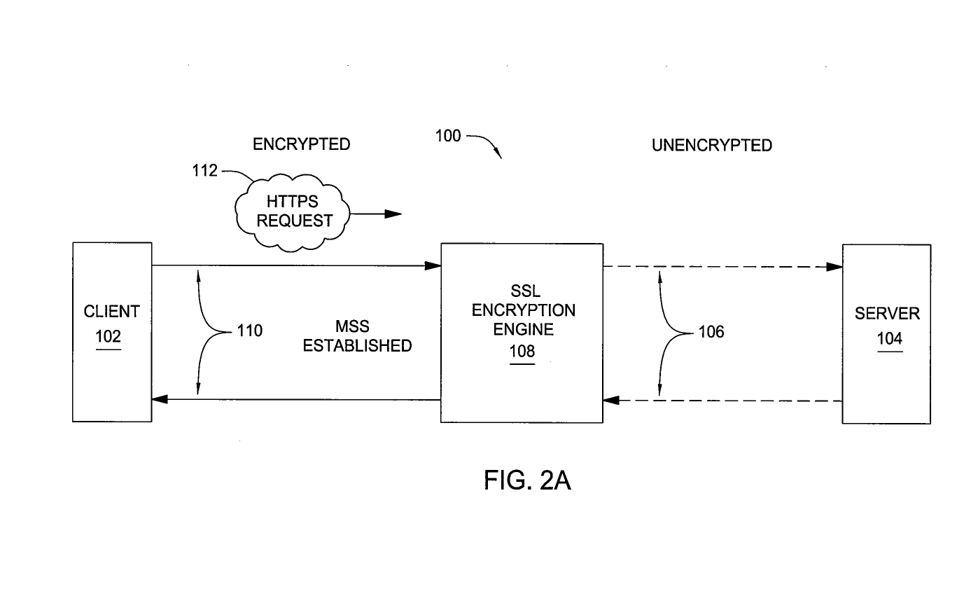

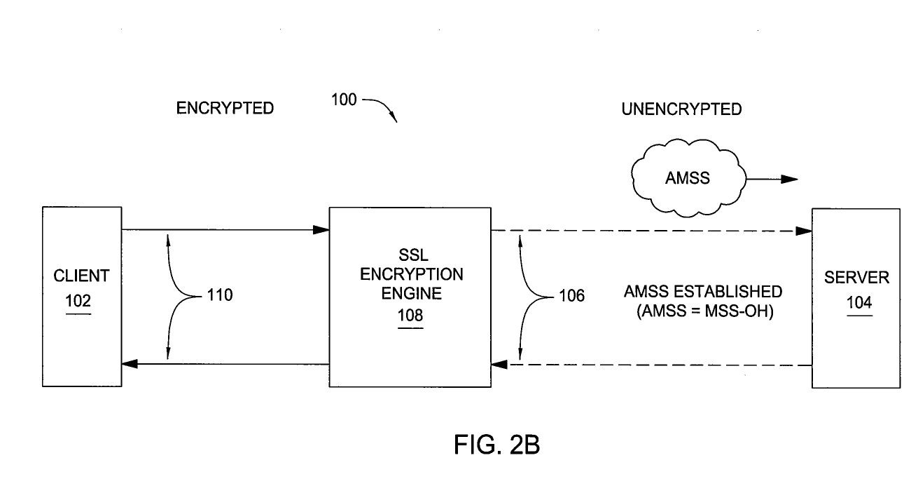

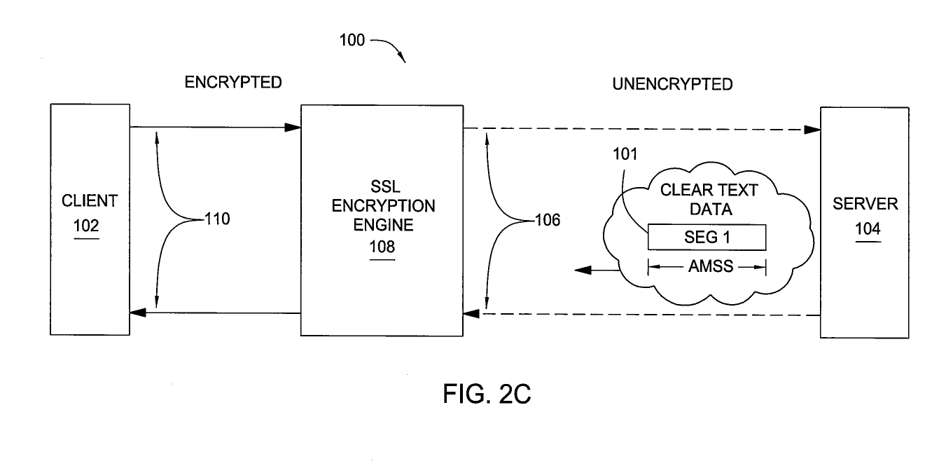

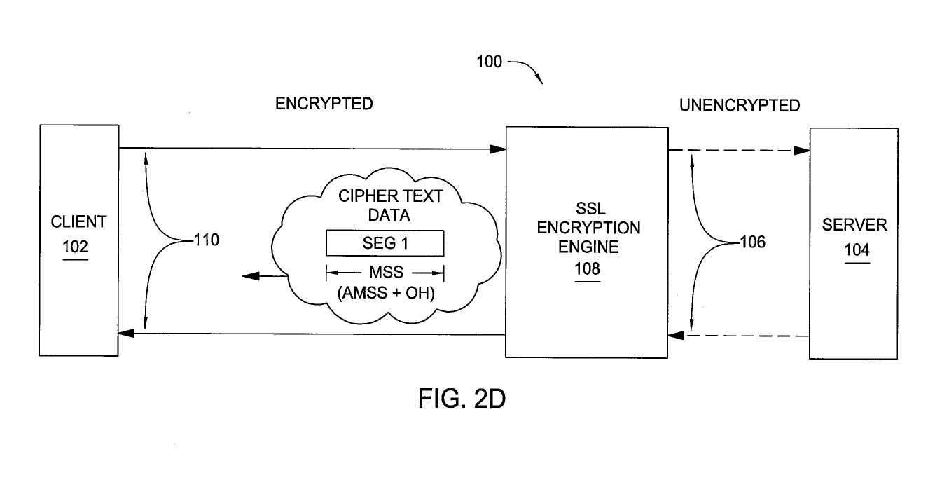

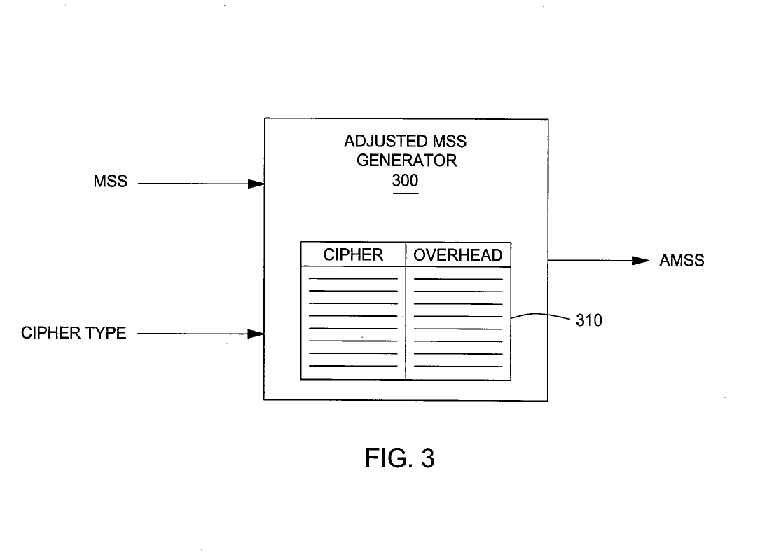

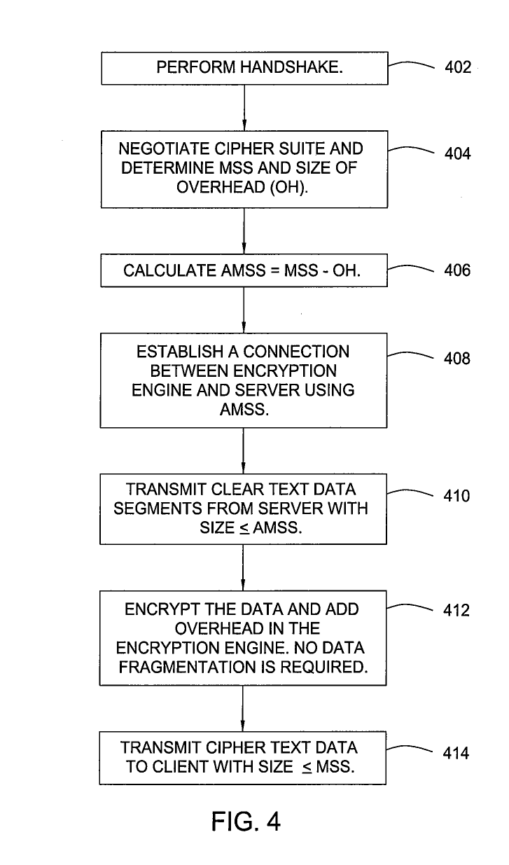

An MSS may be adjusted in accordance with embodiments of the present invention, for example, by an encryption engine, such as the SSL encryption engine 108 shown in FIGS. 2a-2d. Such an encryption engine may utilize a functional block (e.g., any suitable hardware and/or software), such as that shown in FIG. 3, to adjust an MSS based on a particular cipher suite employed. The encryption engine may perform operations shown in the flow diagram of FIG. 4, whose operations may be described with simultaneous reference to FIGS. 2a-2d.

Referring first to FIG. 2a, a block diagram of a network SSL offload environment 100 illustrating only a single client 102 and a network server 104 before a server connection 106 has been established, in accordance with one embodiment of the present invention, is shown. An SSL encryption engine 108 may be deployed at one of several locations throughout a network. During normal operation, the SSL encryption engine 108 may serve as a TCP proxy to bind an encrypted client connection 110, communicating with cipher text data, to the unencrypted server connection 106, communicating with clear text data. The SSL encryption engine 108 may decrypt secure (encrypted) traffic received on the client connection 110 and forward it to the server connection 106. Clear text data from the server 104 may be encrypted by the SSL encryption engine 108 and sent on to the client 102.

Before normal data communication can occur, however, several steps may need to be performed before the server connection 106 is established according to embodiments of the present invention as illustrated in the flowchart of FIG. 4. The first step 402 may be to perform an SSL handshake in an effort to establish a secure connection. An SSL session may be started by sending a request 112 from the client 102 with an HTTPS (Hypertext Transport Protocol Secure) prefix, which may cause port number 443 to be placed in a plurality of data packets for secure access. Port 443 is the number typically assigned to the SSL session as opposed to port 80, the default Web port.

In step 404, the client 102 may exchange the cipher suite, a list of one or more cryptographic algorithms, it will use to encrypt the data with the SSL encryption engine 108. The client 102 may also negotiate an acceptable maximum segment size (MSS) in terms of bytes. For some embodiments incorporating a personal computer (PC) as the client 102, a standard value for the MSS may be used, such as 536 or 1460 bytes.

An overhead in reference to an additional number of bytes associated with the particular encryption process used may be known (e.g., for a given cipher suite). Therefore, this known number of overhead bytes (OH) may then be subtracted from the MSS to form an adjusted maximum segment size (AMSS=MSS-OH) by the SSL encryption engine 108, in step 406. Thus, this AMSS takes into account the overhead that encryption may add to the client connection 110 in future steps and should be less than or equal to MSS for the client 102.

The calculation of AMSS may take place in a functional block (e.g., hardware and/or software) within the SSL encryption engine 108 called the adjusted MSS generator 300 as depicted in FIG. 3. This generator 300 may accept the negotiated MSS and the type of cipher suite as inputs and output the AMSS. The generator 300 may contain a lookup table 310 that yields the encryption overhead associated with a given input cipher type, and the encryption overhead may be stored in any suitable manner, such as a number of bytes or as a percentage of the MSS. This lookup table 310 may be preloaded with overhead amounts for the various cipher suites the encryption engine is to support. Further, the lookup table 310 may be updated to include entries containing overhead values for cipher suites the encryption engine is later modified to support.

Following the calculation of AMSS (at step 406), the SSL encryption engine 108 may establish a connection with the server 104 using AMSS, as illustrated in FIG. 2b, at step 408. In this manner, the server 104 may be prevented from transmitting any data with a segment size larger than AMSS. Once the server connection 106 has been established, however, the server 104 may transmit clear text data segments in step 410 with a size less than or equal to AMSS, as depicted in FIG. 2c.

The SSL encryption engine 108 may receive the clear text data segments and encrypt the information, at step 412. As previously discussed, overhead bytes (e.g., in the form of an SSL header and message authentication code-MAC) may be added to the data segments in the SSL encryption engine 108 during the encryption process. Since this overhead has already been accounted for by adjusting the MSS when generating AMSS, in step 406, the maximum size of these encrypted segments should be equal (or substantially equal) to the MSS of the client 102.

As a result, no further fragmentation of the data by the SSL encryption engine 108 may be required and, therefore, the transmission of small data segments may have been avoided. By doing so, the overall latency of a transaction in the SSL offload environment may have been reduced. The benefits may be particularly noticeable in systems when an aggregation technique, such as the Nagle algorithm, is enabled. As a last step 414, cipher text data with a segment size up to and including MSS may be transmitted by the SSL encryption engine 108 to the client 102 as in FIG. 2d for reception and further processing.

For some embodiments, a user (e.g., a system administrator) may be provided some type of interface (e.g., a graphical user interface-GUI) to configure the encryption engine. For such embodiments, the user may be able to enable/disable the generation of an adjusted MSS. The user may also be able to determine to what extent the MSS is adjusted, for example, by specifying a percentage or number of bytes below the MSS that the AMSS should be. In other words, a user may be able to manually specify how much adjustment is made to the MSS when generating the AMSS. For some embodiments, an adjusted MSS may be generated whenever an aggregation technique, such as a Nagle algorithm is enabled. For other embodiments, a user may be able to specify if and when an adjusted MSS is to be generated.

While the foregoing is directed to embodiments of the present invention, other and further embodiments of the invention may be devised without departing from the basic scope thereof, and the scope thereof is determined by the claims that follow.

1. A method of performing secure network communication, comprising:
performing a handshake between a client and an encryption engine to establish a connection with a first maximum segment size (MSS) for transactions therebetween;
calculating an adjusted maximum segment size (AMSS) that is less than the first MSS, based on a selected cipher suite employed by the encryption engine; and
establishing a connection between the encryption engine and a server, the connection using the AMSS for transactions between the encryption engine and the server.

2. The method of claim 1, wherein the encryption engine is a Secure Sockets Layer (SSL) encryption engine.

3. The method of claim 1, wherein calculating the AMSS comprises subtracting a number of bytes based on the selected cipher suite from the first MSS.

4. The method of claim 1, further comprising receiving, by the encryption engine, at least one clear text data segment from the server with a size less than or equal to the AMSS.

5. The method of claim 4, further comprising adding a number of overhead bytes to the at least one clear text data segment.

6. The method of claim 1, further comprising encrypting the at least one clear text data segment and the number of overhead bytes in the encryption engine to form at least one cipher text data segment with a size less than or equal to the first MSS.

7. The method of claim 1, further comprising transmitting the at least one cipher text data segment to the client.

8. A network device, comprising:
a first interface for establishing a connection with a client;
a second interface for establishing a connection with a server; and
encryption logic configured to establish, on the first interface, a connection with the client with a first maximum segment size (MSS) for transactions therebetween, to calculate an adjusted maximum segment size (AMSS) that is less than the first MSS, based on a selected cipher suite, and to establish a connection between an encryption engine and a server using the AMSS for transactions between the encryption engine and the server.

9. The device of claim 8, wherein the logic is further configured to calculate the AMSS by subtracting a number of bytes based on the selected cipher suite from the first MSS.

10. The device of claim 8, wherein the logic is further configured to:
receive a clear text data segment from the server with a size less than or equal to the AMSS; and
encrypt the clear text data segment, thereby generating cipher text having a size approximately equal to MSS.

11. The device of claim 8, wherein the logic is configured to automatically calculate the AMSS and establish a connection with the server using the AMSS when an aggregation algorithm is enabled.

12. An encryption engine, comprising:
logic configured to establish a secure connection with a client with a first maximum segment size (MSS) for transactions therebetween, to calculate an adjusted maximum segment size (AMSS) that is less than the first MSS, based on a selected cipher suite, and to establish a connection between the encryption engine and a server using the AMSS for transactions between the encryption engine and the server.

13. The encryption engine of claim 12, wherein the logic is further configured to calculate the AMSS by subtracting a number of bytes based on the selected cipher suite from the first MSS.

14. The encryption engine of claim 12, wherein the logic is further configured to:
receive a clear text data segment from the server with a size less than or equal to the AMSS; and
encrypt the clear text data segment, thereby generating cipher text having a size approximately equal to the first MSS.

15. The encryption engine of claim 12, wherein the logic is configured to automatically calculate the AMSS and establish a connection with the server using the AMSS when an aggregation algorithm is enabled.

16. The encryption engine of claim 15, wherein the aggregation algorithm is a Nagle algorithm.

17. A network device, comprising:
first means for establishing a connection with a client;
second means for establishing a connection with a server; and
logic means for establishing, via the first means, a connection with the client with a first maximum segment size (MSS) for transactions therebetween, calculating an adjusted maximum segment size (AMSS) that is less than the first MSS, based on a selected cipher suite, and establishing a connection, via the second means, between an encryption engine and the server using the AMSS for transactions between the encryption engine and the server.

18. The device of claim 17, wherein the logic means is further configured to calculate the AMSS by subtracting a number of bytes based on the selected cipher suite from the first MSS.

19. The device of claim 17, wherein the logic means is further configured to:
receive a clear text data segment from the server with a size less than or equal to the AMSS; and
encrypt the clear text data segment, thereby generating cipher text having a size approximately equal to the first MSS.

20. The device of claim 17, wherein the logic means is configured to automatically calculate the AMSS and establish a connection with the server using the AMSS when an aggregation algorithm is enabled.

21. The device of claim 20, wherein the aggregation algorithm is a Nagle algorithm.
